(19) United States
(12) Patent Application Publication
(10) Pub. No.: US 2008/0139227 A1
(43) Pub. Date: Jun. 12, 2008

(54) STANDBY SCRATCH PAD

(75) Inventors: Marcel Wong, Barseback (SE); Fredrik Wendel, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/609,400

(22) Filed: Dec. 12, 2006

(51) Int. Cl. H04Q 7/20

(52) U.S. Cl. 455/466

(57) ABSTRACT

Disclosed is a method and apparatus that allows users of portable communications devices to enter a message that includes text, symbols, numbers and/or a combination thereof and subsequently select an appropriate application for the message. For example, the user may enter a message using a user input device (e.g., a keypad, a touch screen, a navigation tool, etc.) into a scratchpad and then select a desired destination application for the message. Exemplary application programs include, for example, short message service, electronic mail (E-mail), notepad, etc.

### TECHNICAL FIELD OF THE INVENTION

The present invention relates to a method and apparatus to allow users of mobile and/or wireless electronic devices to enter a message that includes text, symbols, numbers and/or a combination thereof and subsequently select an appropriate application for the message.

### DESCRIPTION OF THE RELATED ART

Mobile and/or wireless electronic devices are becoming increasingly popular. For example, portable communication devices, mobile telephones, portable media players and portable gaming devices are now in wide-spread use. In addition, the features associated with certain types of electronic devices have become increasingly diverse. To name a few examples, many electronic devices have cameras, text messaging capability, Internet browsing capability, electronic mail capability, video playback capability, audio playback capability, image display capability and hands-free headset interfaces.

Mobile telephones and other mobile devices are generally equipped with an alphanumeric keypad. Generally, when the alphanumeric keypad is in the standby mode, any signals received from the keypad are assumed to be numeric. Thus, the device assumes, by default that the user wants to enter a telephone number to be called and/or to send a message to. Under this approach, when the user wants to enter text to be used for any of the applications available on the mobile telephone, the application must be selected prior to entry of the text.

One drawback with such an approach is that it is very technology/application centric and requires many steps and a priori knowledge of the proper application that the text will be used. Oftentimes, the user is aware of the text they want to write and the user's focus is on the text itself, not the application that will communicate the text to the intended recipient. Where to use the text (e.g., which application will the text be used) is a decision that the user will eventually make. There is generally no need for the device to be made aware of this decision until the user is ready to select the application.

### SUMMARY

In view of the aforementioned shortcomings associated with existing prior art, there is a need in the art for a method to allow users of mobile an/or wireless electronic devices (e.g., mobile telephones) to enter text in the form of a message that includes text, symbols, numbers and/or a combination thereof and subsequently select an appropriate application for the text.

An aspect of the invention relates to a method for entering a message while a portable communication device is in standby mode, the method comprising: receiving a text mode signal from a user input device, wherein the text mode signal enables entry of alphabet characters and numeric characters from the user input device; receiving one or more alphabet characters and/or numeric alphanumeric characters from the input device, wherein the received characters form a message; presenting the message in a user-sensible format; storing the message in a non-volatile memory; and selecting a destination application resident on the portable communication device for use of the message.

According to an aspect of the invention, the text mode signal is generated by receiving a predetermined series of signals from the user input device.

According to an aspect of the invention, the text mode signal is generated by a user pressing a dedicated text mode function button.

According to an aspect of the invention, the text mode signal is generated by pressing an alphanumeric key for a predetermined amount of time.

According to an aspect of the invention, the user input device is an alphanumeric keypad.

According to an aspect of the invention, a predictive text application outputs at least on predictive text entry on the display based at least in part on the alphanumeric key received.

According to an aspect of the invention, the predictive text entry is selected by a navigation tool associated with the user input device.

According to an aspect of the invention, the predictive text entry is output in a predetermined manner based on a predictive text algorithm.

According to an aspect of the invention, the predictive text algorithm is one or more of algorithms selected from the group consisting of: T9, Zi, iTap, or eZiText.

According to an aspect of the invention, the destination application is one or more computer applications selected from the group consisting of: a notepad application, a scratchpad application, a short message service application, an electronic mail application, an Internet application.

An aspect of the invention relates to a portable communication device comprising: a memory; a user input device for allowing an associated user to enter alphanumeric characters; a processor coupled to the memory and the user input device, wherein the processor executes an application program within the memory, the application program when executed causing the electronic equipment to: display a text entry screen on a display; receive a text mode signal from the user input device, wherein the text mode signal enables entry of alphabet characters and numeric characters from the user input device; receive one or more alphabet characters and/or numeric alphanumeric characters from the input device, wherein the received characters form a message; present the message in a user-sensible format; and store the message in a non-volatile memory.

According to an aspect of the invention, the text mode signal is generated by receiving a predetermined series of signals from the user input device.

According to an aspect of the invention, the text mode signal is generated by a user pressing a dedicated text mode function button.

According to an aspect of the invention, the text mode signal is generated by pressing an alphanumeric key for a predetermined amount of time.

According to an aspect of the invention, the user input device is an alphanumeric keypad.

According to an aspect of the invention, the memory includes a predictive text application that outputs one or more predictive text entries on the display based at least in part on the signals received from one or more alphanumeric keys.

According to an aspect of the invention, the user input device includes a navigation tool that allows an associated user to select the one or more predictive text entries.

According to an aspect of the invention, the predictive text application includes a predictive text algorithm.

An aspect of the invention relates to a method for entering text in a portable communications device, the method comprising: receiving a text mode signal from a user input device, wherein the text mode signal enables entry of alphabet characters and numeric characters from the user input device; receiving one or more alphabet characters and/or numeric alphanumeric characters from the input device; presenting the received characters in a user-sensible format to an associated user; storing the received characters in a non-volatile memory; and selecting a destination application resident on the portable communication for the received characters.

An aspect of the invention relates to a computer program stored on a machine readable medium, the program being suitable for use in a portable communications device as a scratchpad, wherein: when the program is loaded in memory in the portable communications device and executed causes the portable communications device to: receive a text mode signal from the user input device, wherein the text mode signal enables entry of alphabet characters and numeric characters from the user input device; display a text entry screen on a display; receive one or more alphabet characters and/or numeric alphanumeric characters from the input device; present the message in a user-sensible format; and store the message in a non-volatile memory

Other systems, devices, methods, features, and advantages of the present invention will be or become apparent to one having ordinary skill in the art upon examination of the following drawings and detailed description. It is intended that all such additional systems, methods, features, and advantages be included within this description, be within the scope of the present invention, and be protected by the accompanying claims.

It should be emphasized that the term “comprise/comprising” when used in this specification is taken to specify the presence of stated features, integers, steps or components but does not preclude the presence or addition of one or more other features, integers, steps, components or groups thereof.”

The term “electronic equipment” includes portable radio communication equipment. The term “portable radio communication equipment”, which herein after is referred to as a mobile radio terminal, includes all equipment such as mobile telephones, pagers, communicators, i.e., electronic organizers, personal digital assistants (PDA's), portable communication apparatus, smart phones or the like.

### BRIEF DESCRIPTION OF THE DRAWINGS

The foregoing and other embodiments of the invention are hereinafter discussed with reference to the drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIGS. 1, 2, and 3 are exemplary schematic diagrams illustrating portable communication devices in accordance with aspects of the present invention.

FIG. 4 is an exemplary user input device in accordance with aspects of the present invention.

FIG. 5 is an exemplary screen shot of a scratchpad application in accordance with aspects of the present invention.

FIGS. 6A and 6B are exemplary screen shots of listings of predictive text entries output in a user-sensible format in accordance with aspects of the present invention.

FIG. 7 is an exemplary screen shot for retrieving a saved message from the scratch pad application in accordance with aspects of the present invention.

FIGS. 8 and 9 are exemplary methods in accordance with aspects of the present invention.

### DETAILED DESCRIPTION OF EMBODIMENTS

The present invention is directed to a portable communications device that allows users to enter a message that includes text, symbols, numbers and/or a combination thereof and subsequently select an appropriate application for the message. For example, the user may enter a message using a user input device (e.g., a keypad, a touch screen, a navigation tool, etc.) into a scratchpad and then select a desired destination application for the message. Exemplary application programs include, for example, short message service, electronic mail (E-mail), notepad, etc.

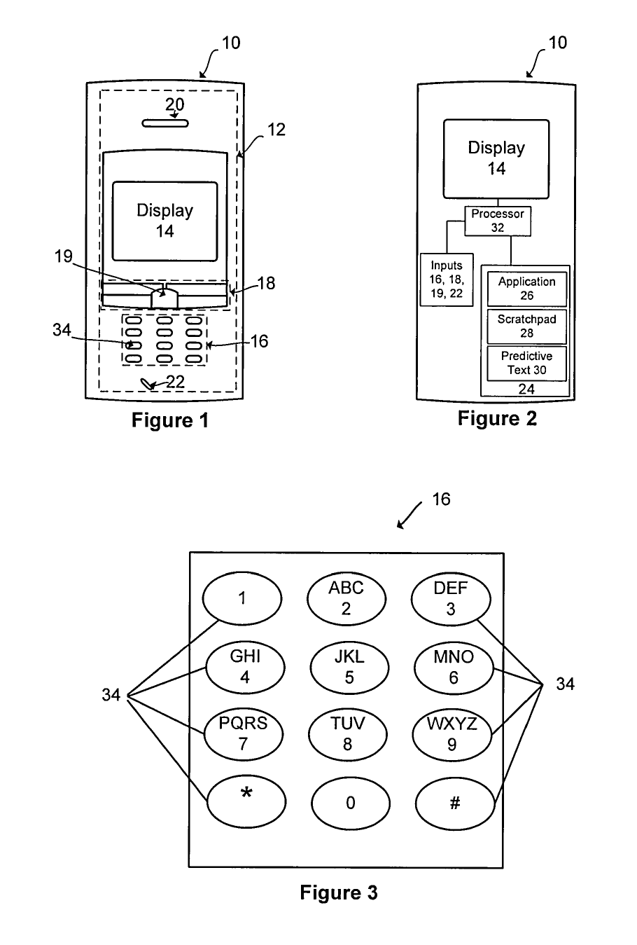

As illustrated in FIG. 1, the portable communications devices 10 may include a user interface 12 that enables the user easily and efficiently to perform one or more communication tasks (e.g., enter a telephone number, identify a contact, select a contact, make a telephone call, receive a telephone call, look up a telephone number, enter a text message, receive text message, etc). The user interface 12 of the portable communications device 10 generally includes one or more of the following components: a display 14, a user input device 16, function keys 18, navigation tool 19, a speaker 20, and a microphone 22.

As shown in FIG. 2, the portable communications device 10 further includes one or more storage devices 24 (e.g., RAM, ROM, etc.) capable of storing application software 26, including a scratchpad application 28 and may optionally include a predictive text application 30, which is discussed in below in detail. The application software 26, scratchpad application 28 and the predictive text application 30 are coupled to a processor 32 for execution. The processor 32 is programmed to perform the functionality described herein, for example, controlling one or more software applications, receiving and storing user input, etc.

The processor 32 also is coupled with conventional input devices (e.g., user input device 16, function keys 18, microphone 22, etc.), and to the device display 14 and the speaker 20. The user interface 12 facilitates controlling operation of the portable communications device 10 including initiating and conducting telephone calls and other communications (e.g., SMS communications, Internet communications, etc.).

The user interface 12 is also one mechanism for the user or operator of the portable communications device 10 to enter characters, letters, words and/or expressions for use by one or more of the applications 26, the scratchpad application 28 and/or the predictive text entry application 30. For example, referring to FIG. 3, an exemplary user input device 16 is shown. The user input device 16 may be any input device that allows a user to enter information (e.g., symbols, alphanumeric characters, words, phrases, graphic images, text images, etc.) into the portable communications device 10. As shown in FIG. 3, the user input device 16 may be an alphanumeric keypad. The user input device 16 includes separate keys 34 for each of the numbers 0-9. The user input device 16 may also include keys that contain symbols (e.g. #, *, @, etc.). One of ordinary skill in the art will readily appreciate that the device display 14 may also be a user input device when properly equipped (e.g., a touch screen display).

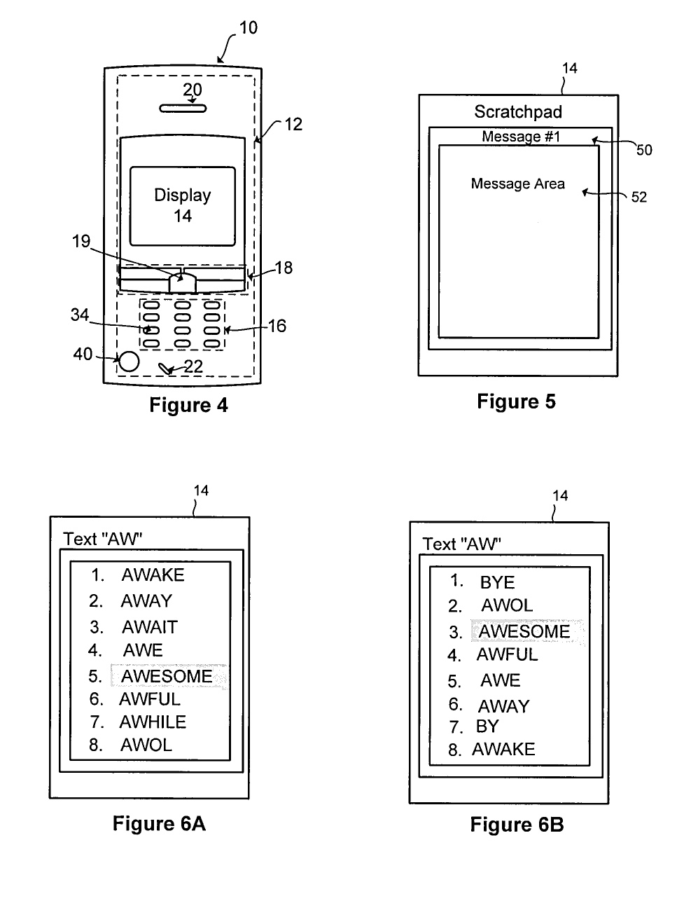

As stated above, when a conventional portable communications device is in the standby mode, signals received from the keypad are assumed to be numeric. The portable communications device 10 includes one or ways to override the default numeric entry setting to allow immediate input of alphabet characters, numbers, symbols, etc. For example, as shown in FIG. 4, the portable communications device 10 may include a dedicated key and/or button 40 that overrides the default numeric entry system. In another embodiment, the default numeric entry system may be overridden by pressing a predetermined sequence of keys (e.g., 777, 999, 123, etc.). In another embodiment, the default numeric entry system may be overridden by learning a user's commonly performed operations (e.g., entering a message, dialing a telephone number, etc.) Learning in this context may be based on a variety ways, for example, monitoring frequency of text entry versus, number entry, receiving a user input device that is different than commonly dialed telephone numbers, etc. Once the mechanism for overriding the default numeric entry system has been triggered, a signal (e.g., a text mode signal) is processed by the processor 32 to initiate a scratchpad application 28.

The scratchpad application 28 may take a variety of forms. For example, as shown in FIG. 5, the scratchpad application 28 may be a window presented on display 14 that provides the user with a graphical user interface (GUI) for viewing the characters and/or symbols that the user is entering into the scratchpad application 28 by the user input device 16. The GUI may include a title bar 50 that identifies or otherwise provides a reference to the viewed message and/or messages and a message area 52 for the user to view the message as the user enters the message.

The characters that comprise a particular alphabet may be distributed over the keys 34 of the user input device 16. For example, referring back to FIG. 3, the twenty-six characters that comprise the English alphabet (e.g., letters A-Z) may be distributed over eight of the ten numeral keys. The user may enter one or more characters by pressing alphanumeric keys 34. The most common system of text input is referred to as “multi-tap”. Using multi-tap, a key is pressed multiple times to access the list of letters on that key. For instance, pressing the “2” key once displays an, “a”, twice displays a “b” and three times displays a “c”. To enter two successive letters that are on the same key, the user must either pause or hit a “next” button. Multi-tap is easy to understand, and can be used without any visual feedback (i.e., the user can type (by pressing an alphanumeric keypad) without looking at the electronic equipment display). Generally the first alphanumeric key entered by the user will be input (e.g., typed) by the multi-tap method described above. For example, if the user wants to enter a word, phrase and/or expression that begins with a “S”, the user would hit the “7” key four times and the letter “S” typically will be output to the display in a user-sensible format. One of ordinary skill in the art will readily appreciate that the alphanumeric keys illustrated are exemplary and may be suitably modified and/or altered based on a variety of design considerations including, for example, the language of user, country of user, a particular dialect, inclusion of a QWERTY user input device or other user input device, etc. Likewise, the sequence of text and numbers displayed when a key is repeatedly pressed may be any suitable order. For example, when the user repeated presses the “7” key, all of the letters (e.g., “P”, “Q”, “R” and “S”) that correspond to the number “7” may be cycled. The order may include upper and/or lower case text, as well as the number represented on the selected key and any other suitable characters and/or symbols may be associated with the selected key.

Typically, once a key is selected or entered, a representation of the symbol (also referred to herein as “user information”) entered will be displayed on the display 14 in a user-sensible format (e.g., letter, word, phrase, image, graphical image, graphical character, text character, etc.) in the scratchpad application 28. The user may continue using the multi-tap method to entire a portion or a complete message. In another embodiment, the predictive text application 30 may be running concurrently with the scratchpad application 28. One of ordinary skill in the art will readily appreciate that the scratchpad application 28 may be integrated with the predictive text application 30 or each application may be separate. As used herein “predictive text application” means software and/or hardware that provides predictive text entries in response to user input (e.g., (e.g., information entered by an associated user through a user input device 16, function keys 18, navigation tool 19 and/or display 14 (e.g., when display 14 is a touch screen).

Once the scratchpad application 28 has been initialized, the user may enter on or more alphanumeric characters from the input device 16 (e.g., alphanumeric keypad). This is generally accomplished by the user selecting a key 34 corresponding to the first letter of the word that the user desires to enter (e.g., by pressing and de-pressing one or more alphanumeric characters, using a menu-driven selection mechanism, etc.). The received input signal corresponding to the selected alphanumeric character may be transmitted to the predictive text application 30.

In response to receiving one or more alphanumeric characters input by the user through user input device 16, the predictive text dictionary application 30 determines whether any predictive text entries correspond to and/or are associated with the received user input. If one or more entries stored in the predictive text application 30 matches all or portion of the received user input, the predictive text entries are output to the user in a user-sensible format (e.g. on the scratchpad application 28 presented on the through display 14).

For example, if the user would like to type and/or enter the word “awesome”, the user could press key 2 and then key 9 in the user input device 16. The scratchpad application 28 would determine that this corresponds to the letters “A”, “B”, “C” and “W”, “X”, “Y”, “Z”, respectively. If the user does not press any additional symbols or keys for a predetermined time or otherwise indicates that a selection of words, phrases and/or expressions corresponding to combinations having a first letter of “A”, “B” or “C” and second letter of “W”, “X”, “Y” or “Z” is desired, information input by the user will be transmitted to the predictive text application 30. In response, assuming the predictive text application 30 has at least one entry associated with the characters (e.g., entries beginning with any of the combination of words, phrases or expressions including, for example: “AW”, “AX”, “AY”, “AZ”, “BW”, “BX”, “BY”, “BZ”, “CW”, “CX”, “CY”, “CZ”, etc.), the predictive text application will display one or more entries associated with the entered text combination on the display 14 in a user sensible format.

Referring to FIGS. 6A and 6B, entries returned by the predictive text application may displayed in any desired format. An exemplary menu-based format is illustrated in FIGS. 6A and 6B. FIG. 6A illustrates presenting the predictive text entries in a menu format on display 14 in a user-sensible format based on alphabetical order of the predictive text entries. FIG. 6B illustrates presenting the predictive text information on display 14 based on an algorithm and/or user behavior that presents the predictive text information according to the probability that a user will select the higher prioritized entry. For example, an algorithm or behavior of the user may indicate that the acronym BYE is the most likely word to be selected, followed in order of priority by the following entries: AWOL, AWESOME, AWFUL, AWE, AWAY, BY, and AWAKE, as shown in FIG. 6B. Additional words, phrases and expressions may also be included in the list of entries and made available to the user by traversing the selection mechanism (e.g., navigation tool 19) up or down through the list of entries. These entries are not shown due to the limited amount of information that may be displayed at one time on a portable communications device 10. Suitable algorithms for prioritizing entries include for example, T9, Zi, iTap, eZiText, etc.

The user may select any one of the entries in a number of ways. For example, the user may press the number on the user input device 16 that corresponds to the entry number associated with the predictive text information presented on the display 14. As another example, the user may also utilize arrow keys, a selection bar, navigation tool or any other suitable mechanism to select the desired entry. Preferably, once a predictive text entry is selected by the user, the entry is displayed in the scratchpad application 28 and stored locally in memory of the portable communications device 10.

Once the desired text is selected, the user may continue inputting a message in the scratchpad application and the process described above will continue for each character and/or characters entered by the user. Once a word and/or phrase is entered and/or otherwise selected, the user may advance a cursor associated with the display to the next word by using the navigation tool 19, arrow keys, and/or any suitable mechanism. This process is repeated until the user has completed entering the desired message.

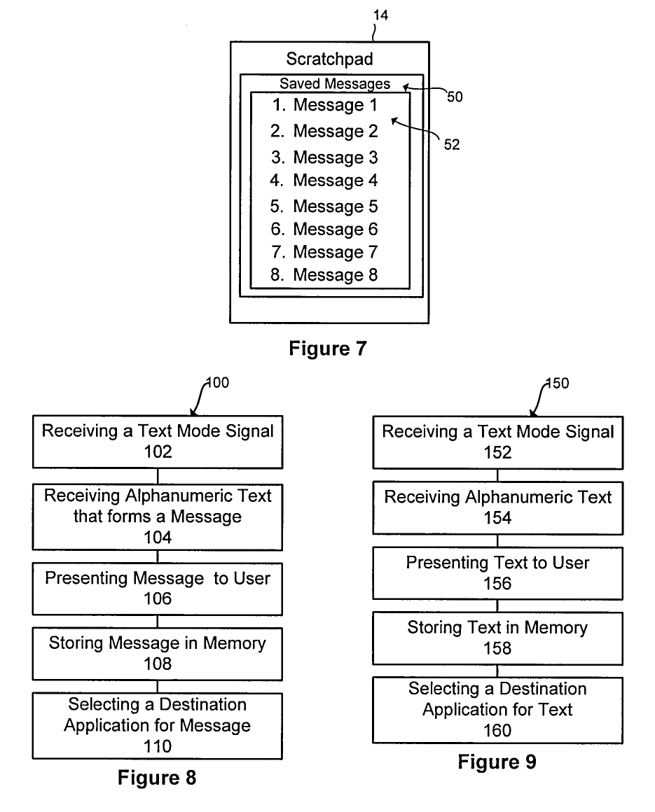

When the user has completed entering a message, the user may save the message in memory (e.g., storage device 24), which is accessible by the scratchpad application 28 for later retrieval. If the user has a variety of messages saved in the scratchpad application 28, the messages may be indexed for retrieval by the user. An exemplary method of retrieval of multiple scratchpad applications is illustrated in FIG. 7. The user may use the user input device 16 and/or user use arrow keys, a selection bar, navigation tool 19 or any other suitable mechanism to select the number and/or title associated with the message desired to be retrieved.

When the user has completed entering a message or after a message has been retrieved by the scratchpad application 28, the user may select another application (e.g., a destination application) for using the message. The application may be chosen from a menu of available applications, activating a dedicated function key for the desired application or any other suitable manner. The destination application may be any application that receives text as input. For example, the destination application may be a short message service application, an electronic mail application, a notepad application, a word processing application, a spreadsheet application, an Internet application, etc.

An exemplary method 100 for entering a message while a portable communication device is in standby mode is illustrated in FIG. 8. As used herein, the phrase “standby mode” means that the portable communication device is in a power “on” state and the device is not currently engaged with remote voice communications. At step 102, the method 100 includes receiving a text mode signal from a user input device. As stated above, the text mode signal may be activated by a number of different manners including a dedicated text mode button, receiving a predetermined series of key presses, pressing a key for a predetermined amount of time, etc. Generally upon activation of the text mode signal, a scratchpad application 28 will be presented on the display 14. The text mode signal enables entry of alphabet characters and numeric characters from the user input device. At step 104, one or more alphabet characters and/or numeric alphanumeric characters are received from the input device, wherein the received characters form a message. At step 106, the message is presented to the user in a user-sensible format as the text is being entered by the user. At step 108, the message is stored in a non-volatile memory (e.g., storage device 24) of the portable communications device 10. At step 110, a destination application resident on the portable communication device is selected for use of the message.

Another exemplary method 150 for entering text in a portable communications device is illustrated in FIG. 9. The method 150 includes at step 152, receiving a text mode signal from a user input device, wherein the text mode signal enables entry of alphabet characters and numeric characters from the user input device. At step 154, one or more alphabet characters and/or numeric alphanumeric characters are received from the input device 16. At step 156, the received characters are presented in a user-sensible format to an associated user. At step 158, the received characters are stored in a non-volatile memory _ of the portable communications device 10. At step 160, a destination application resident on the portable communication is selected for use of the received characters.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. It should also be noted that although the specification lists method steps occurring in a particular order, these steps may be executed in any order, or at the same time.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

What is claimed is:

1. A method for entering a message while a portable communication device is in standby mode, the method comprising:
receiving a text mode signal from a user input device, wherein the text mode signal enables entry of alphabet characters and numeric characters from the user input device;
receiving one or more alphabet characters and/or numeric alphanumeric characters from the input device, wherein the received characters form a message;
presenting the message in a user-sensible format;
storing the message in a non-volatile memory; and
selecting a destination application resident on the portable communication device for use of the message.

2. The method according to claim 1, wherein the text mode signal is generated by receiving a predetermined series of signals from the user input device.

3. The method according to claim 1, wherein the text mode signal is generated by a user pressing a dedicated text mode function button.

4. The method according to claim 1, wherein the text mode signal is generated by pressing an alphanumeric key for a predetermined amount of time.

5. The method according to claim 1, wherein the user input device is an alphanumeric keypad.

6. The method according to claim 1, wherein a predictive text application outputs at least on predictive text entry on the display based at least in part on the alphanumeric key received.

7. The method of claim 6, wherein the predictive text entry is selected by a navigation tool associated with the user input device.

8. The method of claim 6, wherein the predictive text entry is output in a predetermined manner based on a predictive text algorithm.

9. The method of claim 8, wherein the predictive text algorithm is one or more of algorithms selected from the group consisting of: T9, Zi, iTap, or eZiText.

10. The method of claim 1, wherein the destination application is one or more computer applications selected from the group consisting of: a notepad application, a scratchpad application, a short message service application, an electronic mail application, an Internet application.

11. An portable communication device comprising:
a memory;
a user input device for allowing an associated user to enter alphanumeric characters;
a processor coupled to the memory and the user input device, wherein the processor executes an application program within the memory, the application program when executed causing the electronic equipment to:
display a text entry screen on a display;
receive a text mode signal from the user input device, wherein the text mode signal enables entry of alphabet characters and numeric characters from the user input device;
receive one or more alphabet characters and/or numeric alphanumeric characters from the input device, wherein the received characters form a message;
present the message in a user-sensible format; and
store the message in a non-volatile memory.

12. The portable communication device of claim 11, wherein the text mode signal is generated by receiving a predetermined series of signals from the user input device.

13. The portable communication device of claim 11, wherein the text mode signal is generated by a user pressing a dedicated text mode function button.

14. The portable communication device of claim 11, wherein the text mode signal is generated by pressing an alphanumeric key for a predetermined amount of time.

15. The portable communication device of claim 11, wherein the user input device is an alphanumeric keypad.

16. The portable communication device of claim 11, the memory includes a predictive text application that outputs one or more predictive text entries on the display based at least in part on the signals received from one or more alphanumeric keys.

17. The portable communication device of claim 16, the user input device includes a navigation tool that allows an associated user to select the one or more predictive text entries.

18. The portable communication device of claim 17, wherein the predictive text application includes a predictive text algorithm.

19. A method for entering text in a portable communications device, the method comprising:
receiving a text mode signal from a user input device, wherein the text mode signal enables entry of alphabet characters and numeric characters from the user input device;
receiving one or more alphabet characters and/or numeric alphanumeric characters from the input device;
presenting the received characters in a user-sensible format to an associated user;
storing the received characters in a non-volatile memory; and
selecting a destination application resident on the portable communication for the received characters.

20. A computer program stored on a machine readable medium, the program being suitable for use in a portable communications device as a scratchpad, wherein:
when the program is loaded in memory in the portable communications device and executed causes the portable communications device to:
receive a text mode signal from the user input device, wherein the text mode signal enables entry of alphabet characters and numeric characters from the user input device;
display a text entry screen on a display;
receive one or more alphabet characters and/or numeric alphanumeric characters from the input device;
present the message in a user-sensible format; and
store the message in a non-volatile memory.
